(19) United States
(12) Patent Application Publication
(10) Pub. No.: US 2026/0109723 A1
(43) Pub. Date: Apr. 23, 2026

(54) PHOSPHORYLATED BIO-BASED FLAME RETARDANTS

(71) Applicant: UT-Battelle, LLC, Oak Ridge, TN (US)

(72) Inventors: Zoriana Demchuk, Knoxville, TN (US); Antonio J. Aldykiewicz, JR., Knoxville, TN (US); Diana Hun, Lenoir City, TN (US); Mengjia Tang, Oak Ridge, TN (US); Tomonori Saito, Knoxville, TN (US); Kuma Sumathipala, Oak Ridge, TN (US); Karen Paola Cortes Guzman, Oak Ridge, TN (US)

(21) Appl. No.: 19/360,164

(22) Filed: Oct. 16, 2025

Related U.S. Application Data
(60) Provisional application No. 63/708,888, filed on Oct. 18, 2024.

(51) Int. Cl. C07F 9/12; C07F 9/09; C09D 5/18; C09D 7/63

(52) U.S. Cl. CPC C07F 9/12; C07F 9/091; C09D 5/18; C09D 7/63

(57) ABSTRACT

A method of making a flame retardant, and phosphorylated bio-based flame retardants, are provided. The method includes reacting a bio-based-derived starting compound with a phosphate-containing compound or o-phosphoric acid to obtain a phosphorylated bio-based material. The phosphate-containing compound may be diphenyl phosphoryl chloride. The obtained phosphorylated bio-based material may be phosphorylated cardanol, vanillin diphenyl phosphate, vanillyl alcohol diphenyl phosphate, methyl gallate triphenyl phosphate, bis(dihydrogenphosphate) of vanillyl alcohol diglicidyl ether, or bis(dihydrogenphosphate) of bisphenol A diglicidyl ether. An article including the phosphorylated bio-based flame retardant is also provided. The article may be a building material, a textile, a plastic, a foam, an adhesive, packaging, and an electrical housing.

### CROSS-REFERENCE TO RELATED APPLICATIONS

This application claims the benefit of U.S. Provisional Application No. 63/708,888, filed Oct. 18, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to methods of making a bio-based flame retardant and bio-based flame retardants made by the methods.

### BACKGROUND OF THE INVENTION

Flame retardants are an important class of additives that are widely used in various engineered products including plastics, construction materials, furniture, electronics, and the like to provide advanced fire retardancy/suppression to meet fire safety requirements in industry. For a long time, the conventional process of synthesizing flame retardants has utilized petroleum-based feedstocks and converted them to different classes of flame retardants including halides and phosphorous-based compounds, among others. However, due to the toxicity issues associated with the use of halogen-based, petroleum-derived flame retardants, i.e., toxic gases and smoke released while burning, industries are looking for better alternatives.

### SUMMARY OF THE INVENTION

A method of making a flame retardant is provided. The method includes reacting a bio-based-derived starting compound with a phosphate-containing compound or o-phosphoric acid, to obtain a phosphorylated bio-based material.

In specific embodiments, the bio-based-derived starting compound includes at least one hydroxyl group.

In particular embodiments, the bio-based-derived starting compound is reacted with the phosphate-containing compound in the presence of triethylamine at ambient temperature.

In certain embodiments, one or both of the bio-based-derived starting compound and the phosphate-containing compound include at least one phenyl group.

In particular embodiments, the bio-based-derived starting compound has a chemical structure according to Formula (I-A) or (II-A) herein.

In particular embodiments, the bio-based-derived starting compound is one of cardanol, vanillin, vanillyl alcohol, methyl gallate, phloroglucinol, eugenol, or a lignin-derived phenol.

In particular embodiments, the phosphate-containing compound is diphenyl phosphoryl chloride.

In particular embodiments, the obtained phosphorylated bio-based material has a chemical structure according to Formula (I-B) or (II-B) herein.

In particular embodiments, the obtained phosphorylated bio-based material is phosphorylated cardanol, vanillin diphenyl phosphate, vanillyl alcohol diphenyl phosphate, or methyl gallate triphenyl phosphate.

In particular embodiments, the bio-based-derived starting compound is reacted with o-phosphoric acid, and the bio-based-derived starting compound has a chemical structure according to Formula (III-A) herein.

In certain embodiments, the obtained phosphorylated bio-based material has a chemical structure according to Formula (III-B) herein.

In specific embodiments, the bio-based-derived starting compound includes at least one epoxide ring.

In particular embodiments, the bio-based-derived starting compound is reacted with o-phosphoric acid to open the epoxide ring to form a phosphate moiety in the bio-based-derived starting compound.

In particular embodiments, the bio-based-derived starting compound includes at least one phenyl group.

In particular embodiments, the bio-based-derived starting compound has a chemical structure according to Formula (IV-A) herein.

In particular embodiments, the obtained phosphorylated bio-based material has a chemical structure according to Formula (IV-B) herein.

In particular embodiments, the bio-based-derived starting compound is epoxidized cardanol, an epoxidized vanillyl derivative, or an epoxidized derivative of polycarbonate deconstruction.

In particular embodiments, the obtained phosphorylated bio-based material is a bis(dihydrogenphosphate) of vanillyl alcohol diglicidyl ether or a bis(dihydrogenphosphate) of bisphenol A diglicidyl ether.

A flame retardant composition is also provided. The flame retardant composition includes a phosphorylated bio-based material including a phosphate moiety and one or both of at least one phenyl group and at least one aliphatic chain.

In specific embodiments, the composition further includes a solvent.

In specific embodiments, the phosphorylated bio-based material has a thermal stability defined by an onset decomposition temperature (Td5%) in a range of up to 200 and 300° C.

In specific embodiments, the phosphorylated bio-based material is phosphorylated cardanol, vanillin diphenyl phosphate, vanillyl alcohol diphenyl phosphate, methyl gallate triphenyl phosphate, a bis(dihydrogenphosphate) of vanillyl alcohol diglicidyl ether, or a bis(dihydrogenphosphate) of bisphenol A diglicidyl ether.

An article including the flame retardant is also provided.

In specific embodiments, the article is one of a building material, a textile, a plastic, a foam, an adhesive, a caulk, a sealant, packaging, and an electrical housing.

These and other features of the invention will be more fully understood and appreciated by reference to the description of the embodiments and the drawings.

### BRIEF DESCRIPTION OF THE DRAWINGS

FIG. 1 is a schematic view of a chemical reaction to obtain a phosphorylated bio-based material in accordance with some embodiments of the disclosure;

FIG. 2 is a schematic view of a chemical reaction to obtain a phosphorylated bio-based material in accordance with other embodiments of the disclosure;

FIG. 3 is a schematic view of a chemical reaction to obtain a phosphorylated bio-based material in accordance with yet other embodiments of the disclosure;

FIG. 4 is a schematic view of a chemical reaction to obtain a phosphorylated bio-based material in accordance with yet other embodiments of the disclosure;

FIG. 5 is a graph of a thermogravimetric analysis (TGA) of epoxidized cardanol and epoxidized linseed oil;

FIG. 6 is a graph of a thermogravimetric analysis (TGA) of phosphorylated cardanol in accordance with embodiments of the disclosure and phosphorylated linseed oil;

FIG. 7 is a graph of a thermogravimetric analysis (TGA) of phosphorylated vanillin in accordance with embodiments of the disclosure and vanillin starting material;

FIG. 8 is a graph of a thermogravimetric analysis (TGA) of bis(dihydrogenphosphate) of vanillyl alcohol diglicidyl ether in accordance with embodiments of the disclosure and vanillyl alcohol diglicidyl ether (DGEVA) starting material;

FIG. 9 is a graph of a thermogravimetric analysis (TGA) of bis(dihydrogenphosphate) of bisphenol A diglicidyl ether in accordance with embodiments of the disclosure and bisphenol A diglicidyl ether (BADGE) starting material;

FIG. 10 is a graph of a thermogravimetric analysis (TGA) and chemical structure of phenyl-rich vanillin phosphate (VP), vanillyl alcohol diphosphate (VADP), and methyl gallate triphosphate (MGTP) in accordance with embodiments of the disclosure;

FIG. 11 is a graph of flame retardancy of hemp fiber substrates at various loadings of methyl gallate triphosphate (MGTP); and

FIG. 12 is graph of a thermogravimetric analysis (TGA) of hemp fiber substrates at various loadings of methyl gallate triphosphate (MGTP).

### DETAILED DESCRIPTION OF THE CURRENT EMBODIMENTS

As discussed herein, the current embodiments relate to a method of making flame retardants, flame retardant compositions, and articles including the flame retardants. The flame retardants include a phosphorylated bio-based material derived from bio-based-derived starting compounds obtained from biomass. The phosphorylated bio-based material exhibits enhanced fire/flame resistance compared to its non-phosphorylated bio-based-derived starting compound. Biomass represents a tremendous amount of a variety of starting materials for making bio-based materials with rich reserves and wide functionality. Therefore, the synthesis of flame retardants from bio-based feedstocks by the methods disclosed herein can provide one or more of the benefits of low toxicity, abundant raw materials, and comparable flame suppression efficiency to conventional non-biobased counterparts. The resulting flame retardants are non-volatile, easy to process, and safe to handle, and may also have lower cost than conventional flame retardants.

The method of manufacturing flame retardants in accordance with various embodiments of the disclosure includes combining and reacting the bio-based-derived starting compound with either a phosphate-containing compound or o-phosphoric (orthophosphoric) acid. In the embodiments in which the bio-based-derived starting compound is reacted with a phosphate-containing compound, the bio-based-derived starting compound may have a chemical structure or include as a moiety a chemical structure according to the following chemical Formulas (I-A) or (II-A):

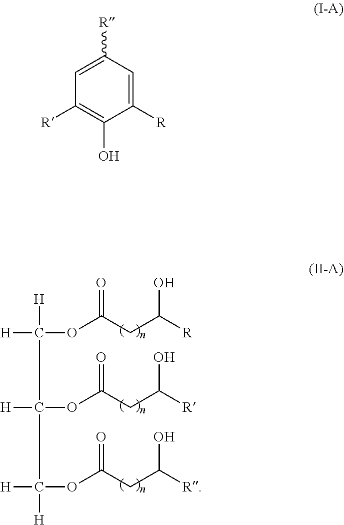

In Formulas (I-A) and (II-A), R, R′, and R″ are each selected from a group of: —H, —OH, —COPh, —OCH₃, —CH₂CH₃, —COOH, —COOCH₃, —COH, —COCH₃, —CH₂OH, and —OPO₃(Ph)₂. One or more of R, R′, and R″ may also be a fully saturated or partially unsaturated aliphatic chain having more than two carbons, i.e., a propyl group, a butyl group, and pentyl group, etc. Further, in Formula (II-A), n is greater than or equal to 1. As such, in these embodiments the bio-based-derived starting compound includes at least one hydroxyl group and/or at least one phenyl group. In certain embodiments, the bio-based-derived starting compound is specifically cardanol, vanillin, vanillyl alcohol, methyl gallate, phloroglucinol, eugenol, a lignin-derived phenol, or other derivative thereof. The bio-based-derived starting compound therefore may be obtained or derived from plants or plant-based materials.

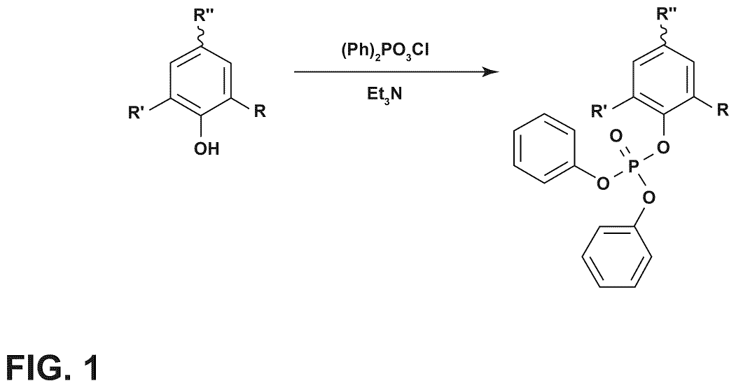

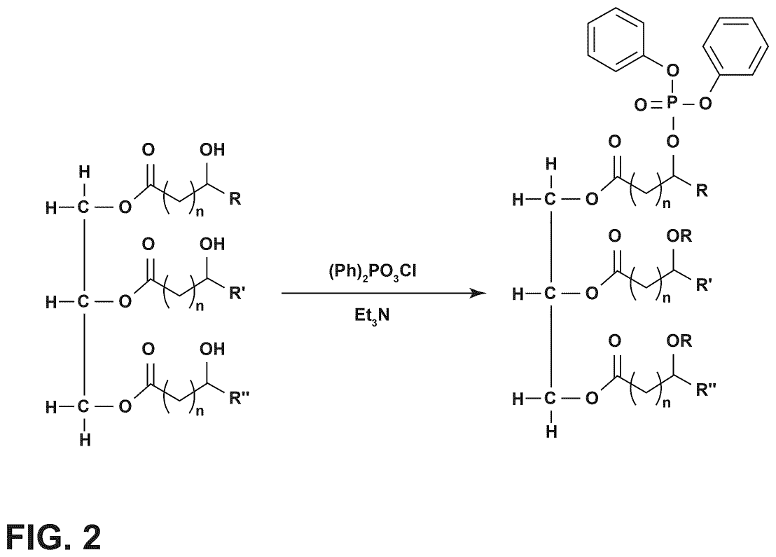

The phosphate-containing compound may be, but not limited to, diphenyl phosphoryl chloride ((Ph)₂PO₃Cl), a di(alkyl) phosphoryl chloride such as dimethylphosphoryl chloride ((CH₃)₂PO₃Cl), diethylphosphoryl chloride ((Et)₂PO₃Cl), and the like. As such, the phosphate-containing compound may also include one or more phenyl groups. With reference to FIGS. 1 and 2, in exemplary embodiments the phosphate-containing compound is mixed and reacted with the bio-based-derived starting compound at ambient or near ambient temperature conditions (or without the addition of heat), for example in a range of from approximately 0° C. to 25° C., optionally 0° C., optionally 5° C., optionally 10° C., optionally 15° C., optionally 20° C., optionally 22° C., optionally 25° C. The reaction is conducted for a period of time such as up to 30 minutes, optionally up to 1 hour, optionally up to 1.5 hours, optionally up to 2 hours, optionally at least 1 hour, optionally at least 2 hours, optionally at least 3 hours, optionally 24 hours. The reaction may also be conducted in the presence of a catalyst such as triethyl amine (Et₃N; (CH₂CH₃)₃N; TEA). The reactants and optional catalyst may also be mixed with a solvent such as, but not limited to, acetone, anhydrous tetrahydrofuran, anhydrous ethyl acetate, anhydrous dichloromethane, and the like. In the case that the bio-based-derived starting compound has the chemical structure or includes as a moiety of Formula (I-A), the phosphorylated bio-based material obtained from the reaction has or includes as a moiety the chemical structure of the following Formula (I-B):

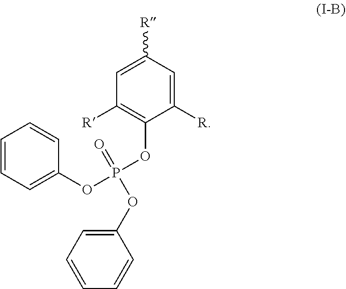

In the case that the bio-based-derived starting compound has or includes as a moiety the chemical structure of Formula (II-A), the phosphorylated bio-based material obtained from the reaction has or includes as a moiety the chemical structure of the following Formula (II-B):

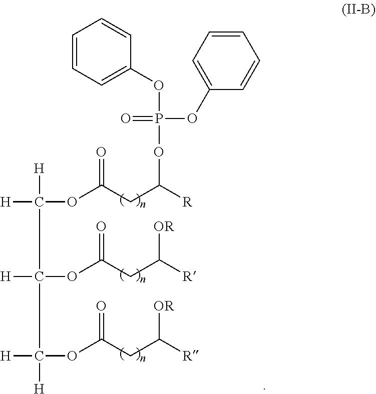

In Formulas (I-B) and (II-B), R, R′, and R″ are each selected from a group of: —H, —OH, —COPh, —OCH₃, —CH₂CH₃, —COOH, —COOCH₃, —COH, —COCH₃, —CH₂OH, and —OPO₃(Ph)₂. One or more of R, R′, and R″ may also be fully saturated or partially unsaturated aliphatic chain having more than two carbons, i.e., a propyl group, a butyl group, and pentyl group, etc. Further, in Formula (II-B), n is greater than or equal to 1. The resulting flame retardants thus include a phosphorylated bio-based material including a phosphate moiety and at least one phenyl (aromatic) group and/or at least one aliphatic chain. In specific embodiments, the obtained phosphorylated bio-based material may be phosphorylated cardanol, vanillin diphenyl phosphate, vanillyl alcohol diphenyl phosphate, or methyl gallate triphenyl phosphate.

In the embodiments in which the bio-based-derived starting compound is reacted with o-phosphoric acid, the bio-based-derived starting compound may have a chemical structure or include as a moiety a chemical structure according to the following chemical Formula (III-A):

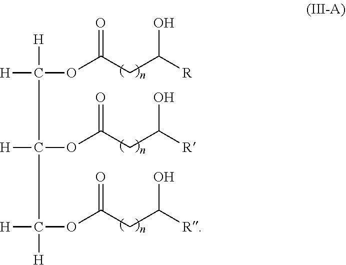

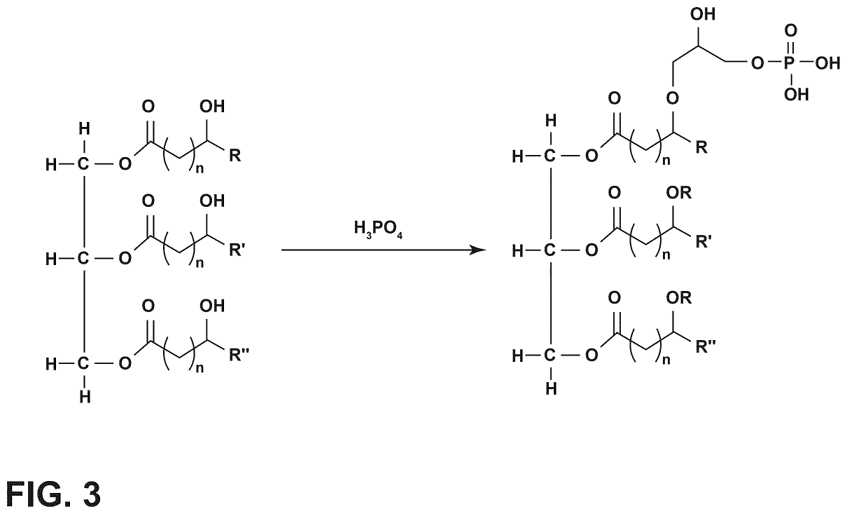

In Formula (III-A), R, R′, and R″ are each selected from a group of —H, —OH, —COPh, —OCH₃, —CH₂CH₃, —COOH, —COOCH₃, —COH, —COCH₃, —CH₂OH, and —CH₂CHOHCH₂OPO(OH)₂. One or more of R, R′, and R″ may also be an aliphatic group having more than two carbons, i.e., a propyl group, a butyl group, and pentyl group, etc. Further, in Formula (III-A), n is greater than or equal to 1. As such, the bio-based-derived starting compound may include one or more phenyl groups. The reaction may or may not be conducted in the presence of a solvent. As shown in FIG. 3, in the case that the bio-based-derived starting compound has or includes as a moiety the chemical structure of Formula (III-A), the phosphorylated bio-based material obtained from the reaction of the bio-based-derived starting compound and o-phosphoric acid has or includes as a moiety the chemical structure of the following Formula (III-B):

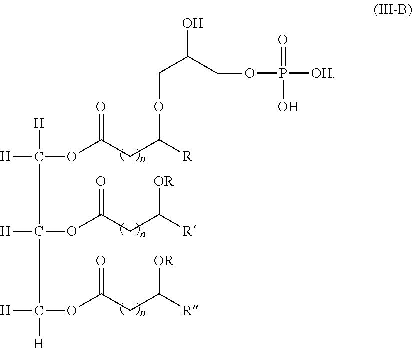

In Formula (III-B), R, R′, and R″ are each selected from a group of —H, —OH, —COPh, —OCH₃, —CH₂CH₃, —COOH, —COOCH₃, —COH, —COCH₃, —CH₂OH, and —CH₂CHOHCH₂OPO(OH)₂. One or more of R, R′, and R″ may also be an alkyl group having more than two carbons, i.e., a propyl group, a butyl group, and pentyl group, etc. Further, in Formula (III-B), n is greater than or equal to 1.

In other embodiments in which the bio-based-derived starting compound is reacted with o-phosphoric acid, the bio-based-derived starting compound may include at least one epoxide ring. In these embodiments, the reaction opens the epoxide ring to form a phosphate moiety in the bio-based-derived starting compound. The bio-based-derived starting compound may have, for example, a chemical structure or include as a moiety a chemical structure according to the following chemical Formula (IV-A):

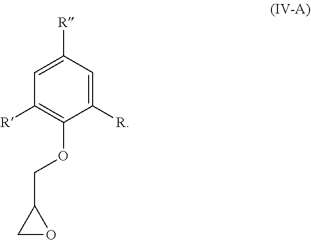

In Formula (IV-A), R, R′, and R″ are each selected from a group of: —H, —OH, —COPh, —OCH₃, —CH₂CH₃, —COOH, —COOCH₃, —COH, —COCH₃, —CH₂OH, and —CH₂CHOHCH₂OPO(OH)₂. One or more of R, R′, and R″ may also be an alkyl group having more than two carbons, i.e., a propyl group, a butyl group, and pentyl group, etc. In certain embodiments, the bio-based-derived starting compound is specifically epoxidized cardanol or an epoxidized vanillyl derivative. In other embodiments, the bio-based-derived starting compound may be an epoxidized derivative of polycarbonate deconstruction. In specific embodiments the bio-based-derived starting compound is bisphenol A diglycidyl ether, tris(4-hydroxyphenyl)methane triglycidyl ether, 3,4-epoxycyclohexylmethyl 3,4-epoxycyclohexanecarboxylate, neopentyl glycol diglycidyl ether, poly(bisphenol A-co-epichlorohydrin) glycidyl end-capped, poly[(phenyl glycidyl ether)-co-formaldehyde], or 4,4′-methylenebis(N,N-diglycidylaniline).

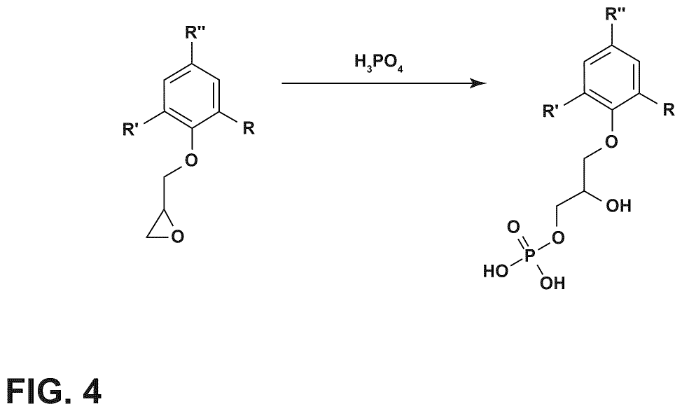

As shown in FIG. 4, in the case that the bio-based-derived starting compound has or includes as a moiety the chemical structure of Formula (IV-A), the phosphorylated bio-based material obtained from the reaction of the bio-based-derived starting compound and o-phosphoric acid has or includes as a moiety the chemical structure of the following Formula (IV-B):

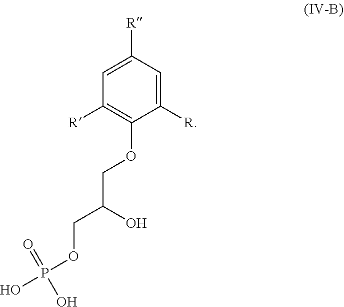

In Formula (IV-B), R, R′, and R″ are each selected from a group of: —H, —OH, —COPh, —OCH₃, —CH₂CH₃, —COOH, —COOCH₃, —COH, —COCH₃, —CH₂OH, and —CH₂CHOHCH₂OPO(OH)₂. One or more of R, R′, and R″ may also be an alkyl group having more than two carbons, i.e., a propyl group, a butyl group, and pentyl group, etc. In specific embodiments, the phosphorylated bio-based material obtained from the reaction of the epoxidized bio-based-derived starting compound and o-phosphoric acid is bis(dihydrogenphosphate) of vanillyl alcohol diglicidyl ether or bis(dihydrogenphosphate) of bisphenol A diglicidyl ether, or a dihydrogenphosphate of tris(4-hydroxyphenyl)methane triglycidyl ether, 3,4-epoxycyclohexylmethyl 3,4-epoxycyclohexanecarboxylate, neopentyl glycol diglycidyl ether, poly(bisphenol A-co-epichlorohydrin) glycidyl end-capped, poly[(phenyl glycidyl ether)-co-formaldehyde], or 4,4′-methylenebis(N,N-diglycidylaniline).

The phosphorylated bio-based flame retardant materials obtained by the methods described above are derived from bio-based materials and include a phosphate moiety and phenyl groups and/or aliphatic chains. The incorporation of phosphorous moieties into the flame retardant chemical structures has several advantages over conventional halogenated flame-retardant approaches by avoiding the generation of toxic gases (hydrogen halides, HCl, HBr) and presenting little to no hazards to people or the environment. The mechanism of flame retardancy of phosphorous-containing compounds is underlined with the generation of radicals ((PO·, PO2·, HPO2·) during the thermal degradation process. These radicals play a crucial role in the flame retardant process by reacting with the H· and OH· to inhibit the radical action and to thereby suppress flame spread. The phosphorylated bio-based flame retardant materials advantageously may exhibit a limiting oxygen index (LOI) of at least approximately 28%. The phosphorylated bio-based flame retardant materials therefore may achieve a UL-94 V-0 flammability rating on wood substrate and may exhibit a char yield that is greater than 10 wt. % when tested above 600° C. in nitrogen, optionally greater than 12 wt. %, optionally greater than 14 wt. %, optionally greater than 16 wt. %, optionally greater than 18 wt. %, optionally greater than 20 wt. %. optionally in a range of approximately 10 to 20 wt. %. Furthermore, the phosphorylated bio-based flame retardant materials may have a thermal stability defined by an onset decomposition temperature (Td5%) in a range of up to approximately 200 to 300° C.

The phosphorylated bio-based flame retardant materials disclosed herein may be applied to or otherwise incorporated into a variety of articles to impart or enhance the fire retardancy of the articles. The articles may be but not limited to, for example, building materials, textiles, plastics, foams, adhesives, packaging, and electrical wiring housings. Examples of building materials include but are not limited to insulation, lumber, wallboard, plywood, particle board, or oriented strand board (OSB). Examples of textiles include but are not limited to woven fabrics, nonwoven fabrics, and protective clothing. Examples of plastics include but are not limited to thermoset resins or thermoplastic polymers selected from, for example, epoxy, polyurethane, polyethylene, or polypropylene. Examples of foams include but are not limited to polyurethane, polyisocyanurate, or polystyrene.

### EXAMPLES

The present method is further described in connection with the following laboratory examples, which are intended to be non-limiting.

Vanillin (0.5 mol) was added into a three mouth, 500 mL round bottom flask equipped with magnetic stirring and an addition funnel. The system was closed and flushed with Ar, then 20 mL of ethyl acetate was added to the flask and the resulting suspension was stirred for 10 minutes under Ar. Subsequently, triethyl amine (0.5 mol) was added into the reaction flask with a syringe through a septum. The system was then placed in an ice bath and allowed to stir for 10 minutes. Diphenyl phosphoryl chloride (0.5 mol) was dissolved in 20 mL of ethyl acetate and added into the addition funnel. The diphenyl phosphoryl chloride solution was then added dropwise with vigorous stirring, and then the ice was allowed to slowly melt and the system to reach room temperature overnight. After stirring the system for 24 hours, the formed precipitate was removed with vacuum filtration and then the filtrate was washed with DI water (×3), brine and dried over sodium sulfate. The solvent was removed using a rotavapor and the product was obtained as a yellow viscous liquid. Vanillyl alcohol and methyl gallate phosphates were also prepared through a method similar to that described for vanillin above.

Flame retardants from epoxidized cardanol and linseed oil (comparative example) were synthesized by reacting phosphoric acid with the epoxy groups. 100 g of epoxidized material was dissolved in 10 g of DI water and 25 g of alcohol and heated up to 60° C. for 30 minutes. Then solutions of different concentrations of orthophosphoric acid were made by mixing acid with isopropanol and then added to the mixture. The reaction continued for 6 hours at 90° C. The product was extracted and purified.

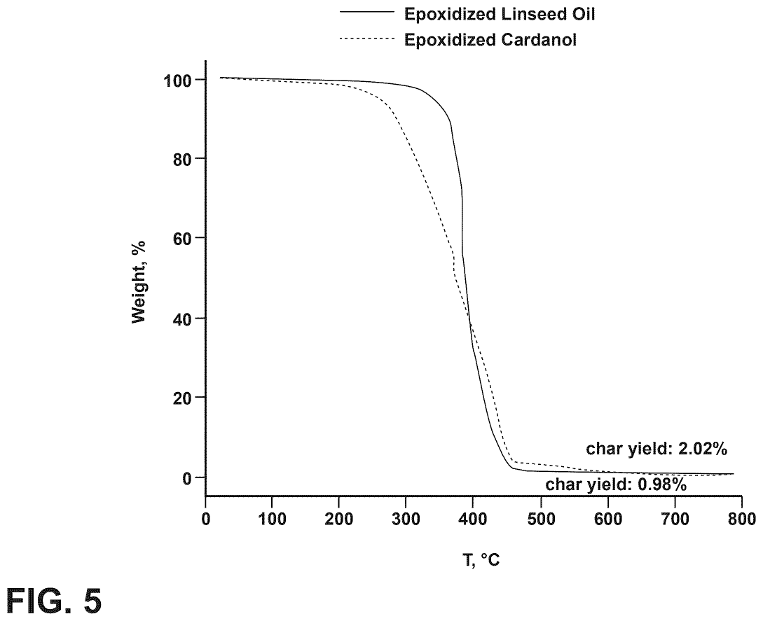

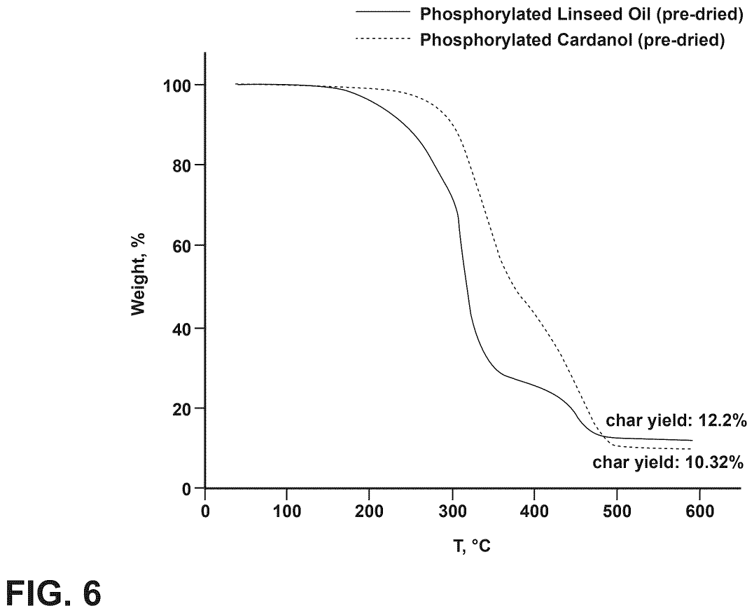

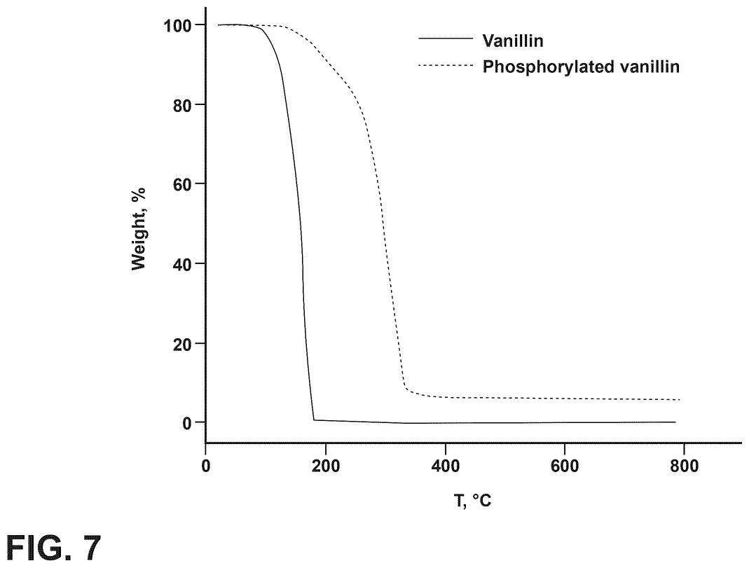

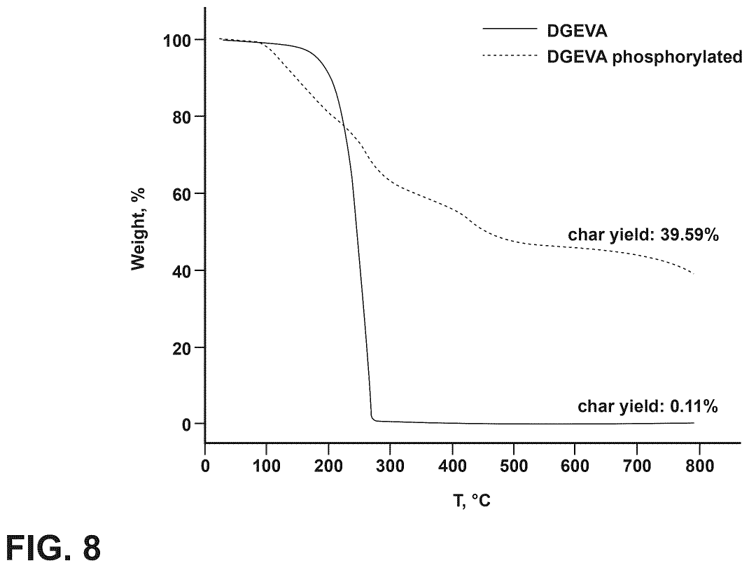

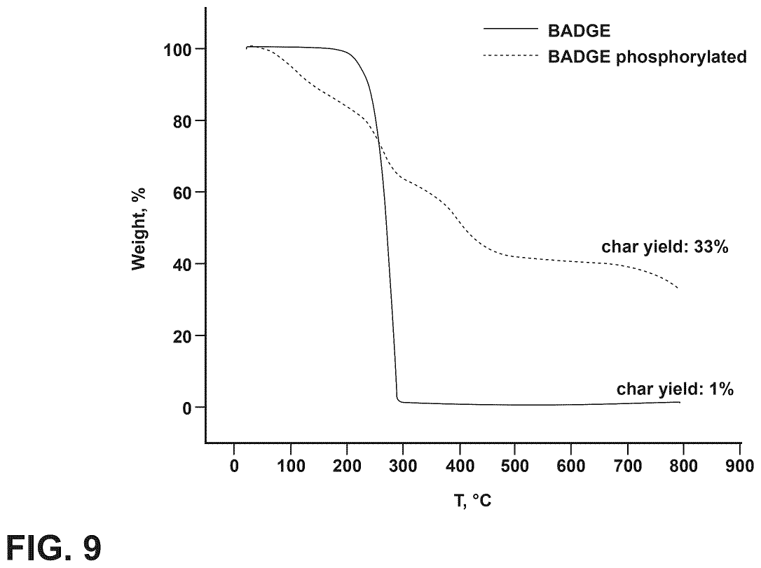

The thermal stability of the plant oil derived flame retardants was studied via thermogravimetric analysis (TGA). The thermograms of the starting materials epoxidized linseed oil (ELO) and cardanol epoxy are shown in FIG. 5, and the thermogram curves for the corresponding flame retardant products after reaction with phosphoric acid are shown in FIG. 6. In addition, thermogram curves for the vanillin starting material and the phosphorylated vanillin flame retardant are shown in FIG. 7, thermogram curves for vanillyl alcohol diglicidyl ether (DGEVA) starting material and the phosphorylated vanillyl alcohol diglicidyl ether flame retardant are shown in FIG. 8, and thermogram curves for bisphenol A diglicidyl ether (BADGE) starting material and the phosphorylated bisphenol A diglicidyl ether flame retardant are shown in FIG. 9. The TGA of certain products indicated a lower initial decomposition temperature than the starting materials, which can be attributed to the decomposition of the phosphate moieties into phosphorous acid derivatives. The phosphorous acid derived decomposition products can contribute to the formation of a carbonaceous char layer that can in turn contribute to the stopping of the flame spreading. This is confirmed in the TGA curves where the char yield of the starting materials was below 2% and the char residue of the products increased above 10%, in some cases above 30%.

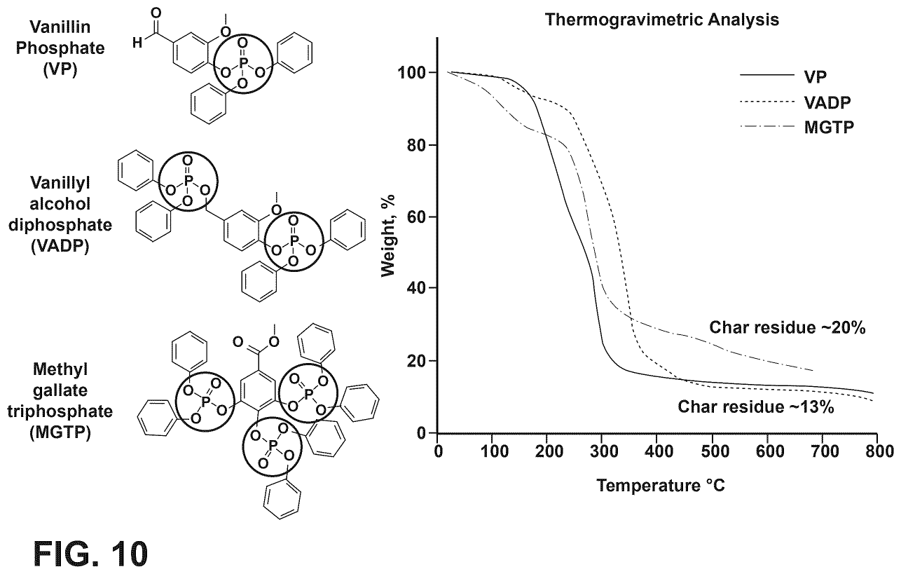

The phosphorylated derivatives vanillin (vanillin phosphate, VP), vanillyl alcohol (vanillyl alcohol diphosphate, VADP), and methyl gallate (methyl gallate triphosphate, MGTP) could exhibit increased char residue due to being rich in phenyl groups. The measured TGA of these new phenyl rich flame retardants is shown in FIG. 10. Although initial decomposition temperatures were low, this could be attributed at the presence of organic solvent which was observed in ¹H NMR spectra. However, this preliminary TGA analysis illustrated important findings regarding the increase in the char yield of the three phenyl rich flame retardants. It is important to highlight that the char yield of MGTP is approximately 20 wt. % which may be attributed to the high content of aromatic moieties in the molecule, and the phosphate moieties which propitiate the formation of this rich carbonaceous layer. Similarly, the measured TGA of bis(dihydrogenphosphate) of vanillyl alcohol diglicidyl ether and bis(dihydrogenphosphate) of bisphenol A diglicidyl ether in FIGS. 8 and 9 indicate a high char yield of approximately 39% and 33%, respectively.

To characterize the efficacy of these materials to stop the flame spreading, a solvent-assisted method was used for treating wood and hemp fiber substrates, which allowed higher penetration of the MGTP flame-retardant material into the substrate as well as ensuring a homogenous dispersion. A solution of 10 to 50 wt. % of the MGTP flame retardant was prepared using isopropyl alcohol (IPA) as a solvent. Then the weight of the pre-dried wood substrates was recorded and the substrates were subsequently submerged into the solution of flame retardants for 2 minutes. Then the substrates were removed and pat dried with a paper towel, followed by drying in a vacuum oven at 60° C. for 24 hours. The weight of the wood substrates was recorded, and the percentage loading of flame retardant was calculated. A procedure similar to the treatment of the wood substrates was followed for the treatment of hemp fibers and adjusted slightly for the processing of loose fibers. 1 gram samples of the hemp fibers were spread into a tray and the solution of flame retardant was sprayed into them with a spray bottle, while making sure to turn the sample halfway to evenly coat all the material. The fibers were dried in a vacuum oven at 60° C. for 24 hours. The weight of the resulting fibers was recorded, and the percentage loading of flame retardant was calculated.

The flammability tests were carried out according to the 94HB horizontal burning test listed in UL 94, and the procedure was adapted to evaluate the performance of the present bio-based flame retardants. When studying the flammability of the neat wood, it was observed that after exposure to the flame for 30 seconds, the sample continued to combust well past the first 1 inch of the sample and exhibited burning times of above 30 seconds. The flame spreading did not stop after the 5-inch mark so the sample was dropped into a water bath to extinguish the flame. However, for the wood sample loaded with 10 wt. % of the MGTP flame retardant, the flame was completely extinguished at around ¼ inch or 3 seconds after exposure to the flame. This preliminary flammability testing indicates that the MGTP flame retardant efficiently prevents the flame spreading of the substrate.

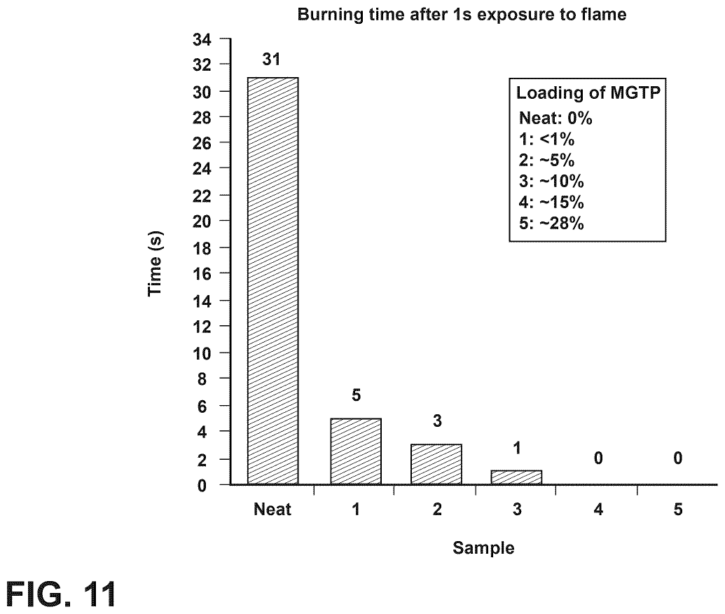

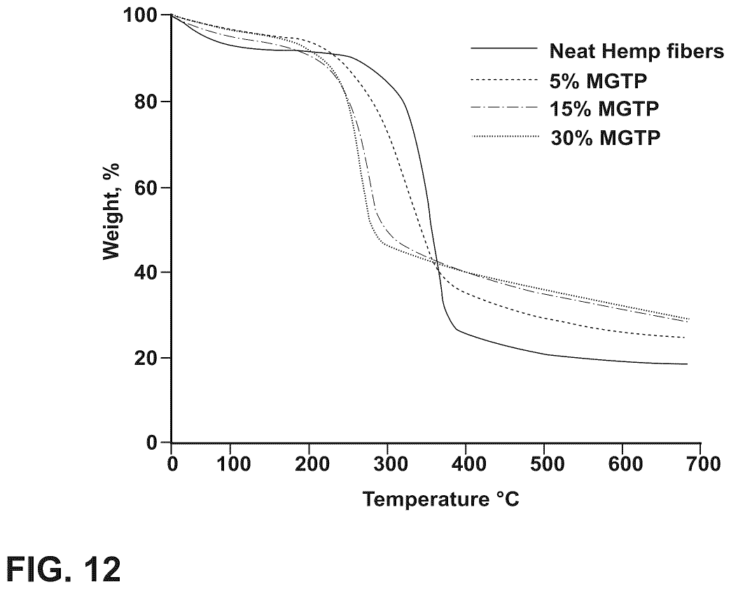

To evaluate the performance of the MGTP flame retardant applied to hemp fiber substrates, the previous procedure was adapted to allow handling of a loose fiber sample, and the preliminary results are shown in FIG. 11 (Neat Hemp Fibers: 0 wt. % MGTP in IPA; Sample 1: <1 wt. % MGTP in IPA; Sample 2: 5 wt. % MGTP in IPA; Sample 3: 10 wt. % MGTP in IPA; Sample 4: 15 wt. % MGTP in IPA; Sample 5: 28 wt. % MGTP in IPA). The plot shows the burning times of each sample and indicates that even the lowest loading of <1 wt. % reduces the burning time of the sample from 31 seconds to 5 seconds. The sample with 5 wt. % loading had burning times of 3 seconds, and the combustion of the hemp fibers was completely inhibited by the char layer formation in the material owing to the presence of the MGTP flame retardant. Further thermogravimetric analysis of the hemp fibers with the different MGTP loadings was carried out to confirm that the char residue increased as the loading of MGTP increased. The TGA results are shown in FIG. 12. The char yields were calculated as the following: Neat hemp fibers=18% char yield; 5 wt. % MGTP sample=25% char yield; 15 wt. % MGTP sample=28.5% char yield; and 30 wt. % MGTP sample=29.2% char yield.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of making a flame retardant, the method comprising:
reacting a bio-based-derived starting compound with one of: i) a phosphate-containing compound; or ii) o-phosphoric acid, to obtain a phosphorylated bio-based material.

2. The method of claim 1, wherein the bio-based-derived starting compound includes at least one hydroxyl group.

3. The method of claim 2, wherein the bio-based-derived starting compound is reacted with the phosphate-containing compound in the presence of triethylamine at ambient temperature.

4. The method of claim 3, wherein one or both of the bio-based-derived starting compound and the phosphate-containing compound include at least one phenyl group.

5. The method of claim 2, wherein the bio-based-derived starting compound has a chemical structure of Formula (I-A) or (II-A): 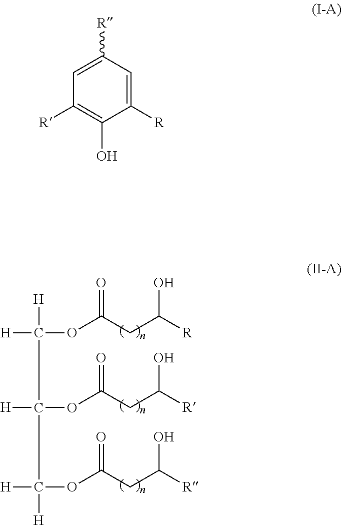
wherein n is greater than or equal to 1, and each of R, R′, and R″ are selected from a group consisting of: —H, —OH, —COPh, —OCH₃, —CH₂CH₃, —COOH, —COOCH₃, —COH, —COCH₃, —CH₂OH, and —OPO₃(Ph)₂.

6. The method of claim 2, wherein the bio-based-derived starting compound is one selected from a group consisting of: i) cardanol; ii) vanillin; iii) vanillyl alcohol; iv) methyl gallate; v) phloroglucinol; vi) eugenol; and vii) a lignin-derived phenol.

7. The method of claim 2, wherein the phosphate-containing compound is diphenyl phosphoryl chloride.

8. The method of claim 2, wherein the obtained phosphorylated bio-based material has a chemical structure of Formula (I-B) or (II-B): 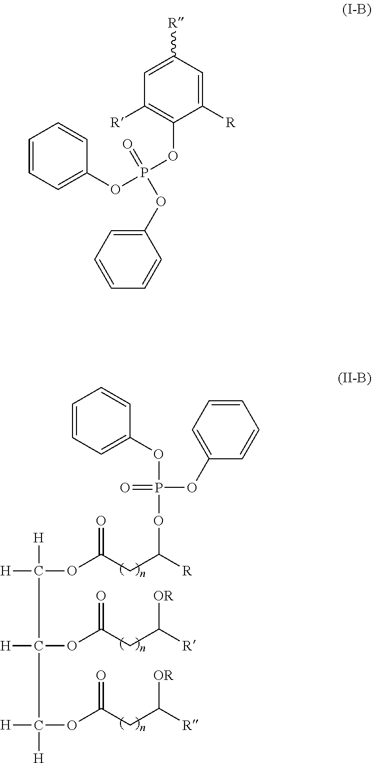
wherein n is greater than or equal to 1, and each of R, R′, and R″ are selected from a group consisting of: —H, —OH, —COPh, —OCH₃, —CH₂CH₃, —COOH, —COOCH₃, —COH, —COCH₃, —CH₂OH, and —OPO₃(Ph)₂.

9. The method of claim 2, wherein the obtained phosphorylated bio-based material is one of: i) phosphorylated cardanol; ii) vanillin diphenyl phosphate; iii) vanillyl alcohol diphenyl phosphate; and iv) methyl gallate triphenyl phosphate.

10. The method of claim 2, wherein the bio-based-derived starting compound is reacted with o-phosphoric acid, and the bio-based-derived starting compound has a chemical structure of Formula (III-A): 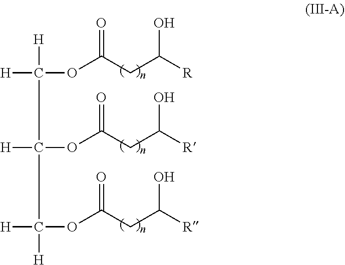
wherein n is greater than or equal to 1, and each of R, R′, and R″ are selected from a group consisting of: —H, —OH, —COPh, —OCH₃, —CH₂CH₃, —COOH, —COOCH₃, —COH, —COCH₃, —CH₂OH, and —CH₂CHOHCH₂OPO(OH)₂.

11. The method of claim 10, wherein the obtained phosphorylated bio-based material has a chemical structure of Formula (III-B): 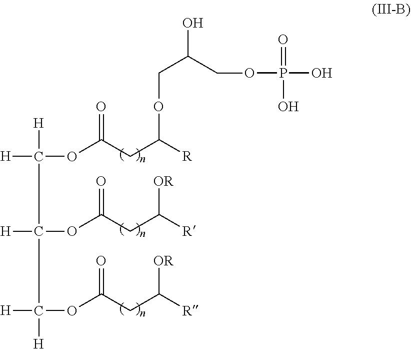
wherein n is greater than or equal to 1, and each of R, R′, and R″ are selected from a group consisting of: —H, —OH, —COPh, —OCH₃, —CH₂CH₃, —COOH, —COOCH₃, —COH, —COCH₃, —CH₂OH, and —CH₂CHOHCH₂OPO(OH)₂.

12. The method of claim 1, wherein the bio-based-derived starting compound includes at least one epoxide ring.

13. The method of claim 12, wherein the bio-based-derived starting compound is reacted with o-phosphoric acid to open the epoxide ring to form a phosphate moiety in the bio-based-derived starting compound.

14. The method of claim 12, wherein the bio-based-derived starting compound includes at least one phenyl group.

15. The method of claim 12, wherein the bio-based-derived starting compound has a chemical structure of Formula (IV-A): 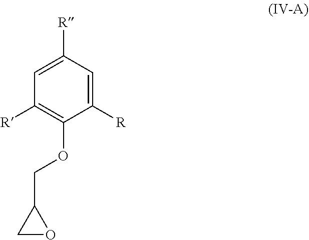
wherein each of R, R′, and R″ are selected from a group consisting of: —H, —OH, —COPh, —OCH₃, —CH₂CH₃, —COOH, —COOCH₃, —COH, —COCH₃, —CH₂OH, and —CH₂CHOHCH₂OPO(OH)₂.

16. The method of claim 12, wherein the obtained phosphorylated bio-based material has a chemical structure of Formula (IV-B): 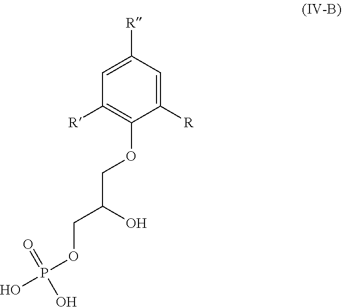
wherein each of R, R′, and R″ are selected from a group consisting of: —H, —OH, —COPh, —OCH₃, —CH₂CH₃, —COOH, —COOCH₃, —COH, —COCH₃, —CH₂OH, and —CH₂CHOHCH₂OPO(OH)₂.

17. The method of claim 12, wherein the bio-based-derived starting compound is one selected from a group consisting of: i) epoxidized cardanol; ii) an epoxidized vanillyl derivative; and iii) an epoxidized derivative of polycarbonate.

18. The method of claim 12, wherein the obtained phosphorylated bio-based material is one of: i) bis(dihydrogenphosphate) of vanillyl alcohol diglicidyl ether; and ii) bis(dihydrogenphosphate) of bisphenol A diglicidyl ether.

19. A flame retardant composition comprising:
a phosphorylated bio-based material including a phosphate moiety and one or both of: i) at least one phenyl group; and ii) at least one aliphatic chain.

20. The flame retardant composition of claim 19, further comprising a solvent.

21. The flame retardant composition of claim 19, wherein the phosphorylated bio-based material has a thermal stability defined by an onset decomposition temperature (Td5%) in a range of up to 200 and 300° C.

22. The flame retardant composition of claim 19, wherein the phosphorylated bio-based material is one of: i) phosphorylated cardanol; ii) vanillin diphenyl phosphate; iii) vanillyl alcohol diphenyl phosphate; iv) methyl gallate triphenyl phosphate; v) bis(dihydrogenphosphate) of vanillyl alcohol diglicidyl ether; and vi) bis(dihydrogenphosphate) of bisphenol A diglicidyl ether.

23. An article comprising the flame retardant composition of claim 19.

24. An article comprising the flame retardant obtained by the method of claim 1.

25. The article of claim 23, wherein the article is one of a building material, a textile, a plastic, a foam, an adhesive, packaging, and an electrical housing.

26. The article of claim 24, wherein the article is one of a building material, a textile, a plastic, a foam, an adhesive, a caulk, a sealant, packaging, and an electrical housing.
